(19) United States
(12) Patent Application Publication
(10) Pub. No.: US 2022/0236482 A1
(43) Pub. Date: Jul. 28, 2022

(54) Optical Waveguide Chip

(71) Applicant: Nippon Telegraph and Telephone Corporation, Tokyo (JP)

(72) Inventors: Satomi Katayose, Musashino-shi, Tokyo (JP); Nobutatsu Koshobu, Musashino-shi, Tokyo (JP); Katsuhiko Hirabayashi, Musashino-shi, Tokyo (JP); Ryoichi Kasahara, Musashino-shi, Tokyo (JP); Mikitaka Ito, Musashino-shi, Tokyo (JP)

(21) Appl. No.: 17/615,744

(22) PCT Filed: Jun. 3, 2019
(86) PCT No.: PCT/JP2019/021980

§ 371 Date: Dec. 1, 2021

(51) Int. Cl. G02B 6/12; G02B 6/125

(52) U.S. Cl. CPC G02B 6/12004; G02B 6/125; G02B 2006/1215; G02B 6/12002; G02B 6/12014

(57) ABSTRACT

There is provided an optical waveguide chip. In the optical waveguide chip, an optical waveguide circuit includes a substrate, a lower clad layer laminated on the substrate, a core layer that is laminated on the lower clad layer and corresponds to a propagation path of an optical signal, and an upper clad layer laminated on the core layer; the upper and lower clad layers in a region that does not correspond to the propagation path of the optical signal are removed across to an edge of the chip; the region from which the upper and lower clad layers have been removed is filled with a light absorbing material; and a height of the filled light absorbing material is higher than a height of an uppermost surface of the upper clad layer.

### TECHNICAL FIELD

The present invention relates to optical waveguide chips, and more particularly relates to an optical waveguide chip provided with a light blocking structure for eliminating stray light.

### BACKGROUND ART

In recent years, the importance of optical devices has increased in the medical display field and the like. It is requested that the optical devices having been used in the communication field be applied to fields other than the communication field, and in particular, optical devices based on a planar lightwave circuit (PLC) have drawn attention.

The PLC is a type of circuit in which an optical circuit is formed on a semiconductor substrate or the like by applying semiconductor processing techniques such as photolithography and dry etching, and is able to implement an optical multiplexer/demultiplexer, an optical switch, a wavelength multiplexer/demultiplexer, and the like by circuit patterns. The PLC has been used as a primary component of optical networks in various applications because the PLC has an excellent feature for mass production and is highly reliable.

In the PLC, stray light propagating through a portion other than optical waveguides may enter a light receiving element or the like and may degrade the signal, and therefore it is important to eliminate/suppress the stray light. As methods for stray light suppression, conventionally, the following have been conceived: a groove is formed by removing a clad of an optical waveguide (for example, see Patent Literature (PTL) 1); a groove formed is filled with a light blocking material (for example, see PTL 2); a light blocking material is provided on an outgoing-side end surface of an optical waveguide excluding a core (for example, see PTL 3); and an outgoing direction of light is organized to be perpendicular to an incident direction of light in a light receiving element (for example, see PTL 4).

In a structure in which a groove is formed in a clad layer of an optical waveguide, or a groove is filled with a light blocking material, stray light that is generated in a branch portion, a bend portion, or the like of the optical waveguide and propagates through the clad layer can be eliminated. However, stray light may be generated in a joining portion between an optical fiber and an input waveguide, or the like, and may propagate through the space. Such stray light is difficult to eliminate.

In a top view of an optical waveguide chip 10 of conventional art in FIG. 1, incident light 1, which enters from the left end of the drawing, passes through a fiber 3 within a fiber block 2 and enters an input waveguide 5 of the optical waveguide chip 10. The incident light 1 having passed through the input waveguide 5 of the optical waveguide chip 10 is split into two beams of light in a 3-dB branch optical waveguide 6.

One of the two beams of split light propagates through a first output waveguide 7a and is output as output light 8a to a light receiving element 12. Likewise, the other one of the two beams of split light having been split in the 3-dB branch optical waveguide 6 propagates through a second output waveguide 7b and is output as output light 8b to the light receiving element 12. A groove filled with a light blocking material 9 is formed between the first output waveguide and the second output waveguide. Some of beams of stray light generated in respective portions and exemplified by hatched arrows are absorbed by the light blocking material 9, but some of the beams thereof slither past the light blocking material 9.

As illustrated in a substrate cross-sectional view of the optical waveguide chip 10 of conventional art in FIG. 2 (a cross-sectional view taken along a line II-II in FIG. 1), a member called a fixture plate 4 is attached on a top surface of the optical waveguide chip 10 while end surfaces thereof being flush with each other. The fiber block 2, the fixture plate 4, and the like are provided in order to, when the PLC and the optical fiber are bonded and fixed to each other, increase the bonding cross-sectional area and enhance mechanical strength of the bonding portion. The fiber block, the fixture plate 4, and the like are generally made of glass or the like (for example, see PTL 6). Because of this, there exists stray light that leaks from the fixture plate 4 and slithers past the upper portion of the light blocking material 9.

As illustrated in FIGS. 1 and 2, with the structure of the optical waveguide chip 10 of conventional art, the stray light that is directly incident on the light blocking material 9 can be eliminated, but it is difficult to eliminate the stray light propagating through a side portion of the chip, the space over the chip, and the like.

With the structure in which a groove formed in a clad layer is filled with a light blocking material as disclosed in PTL 2, it is difficult to fill the light blocking material across to an edge of the substrate because the light blocking material flows out from the edge, and thus it is difficult to completely eliminate stray light even in a waveguide layer.

A structure is conceivable, as disclosed in PTL 4, in which an outgoing direction of light is made perpendicular to an incident direction of light to prevent stray light generated in a joining portion between an optical fiber and an input waveguide, or the like from entering a light receiving element; however, in this structure, a long circuit length is needed to bend the optical waveguide, and the optical waveguide chip becomes large in size.

### CITATION LIST

### Patent Literature

PTL 1: JP 04-333829 A

PTL 2: JP 09-005548 A

PTL 3: JP 2001-350043 A

PTL 4: JP 2018-180513 A

PTL 5: JP 2014-002282 A

PTL 6: JP 2014-048628 A

### SUMMARY OF THE INVENTION

### Technical Problem

As illustrated in FIG. 3 and FIG. 4 (a cross section taken along a line IV-IV in FIG. 3), there is also a method of providing a light blocking structure such as a light blocking plate 11 having an opening (a pin hole 14, a slit, or the like) in a position corresponding to a light input/output face of an optical waveguide on a light input/output end surface rather than on an optical waveguide chip (for example, see PTL 5).

However, in the method of providing a light blocking structure having an opening on the light input/output end surface, the light blocking structure such as the light blocking plate 11 is formed on the substrate end surface of the chip after the formation of the waveguides, and thus the manufacturing process has a plurality of steps, which increases the production cost.

The present invention has been conceived in view of such problems, and an object of the present invention is to provide an optical waveguide chip capable of eliminating stray light at low cost, without forming a light blocking structure or the like on an end surface of a waveguide substrate (chip) and without increasing steps in the manufacturing process, and to provide a manufacturing method for the optical waveguide chip.

### Means for Solving the Problem

Examples of embodiments of the present invention include the following configurations to achieve the above object.

### Configuration 1

An optical waveguide chip includes an optical waveguide circuit. The optical waveguide circuit includes a substrate, a lower clad layer laminated on the substrate, a core layer that is laminated on the lower clad layer and corresponds to a propagation path of an optical signal, and an upper clad layer laminated on the core layer. The upper clad layer and the lower clad layer in a region that does not correspond to the propagation path of the optical signal are removed across to an edge of the optical waveguide chip, the region from which the upper clad layer and the lower clad layer have been removed is filled with a light absorbing material, and a height of the filled light absorbing material is higher than a height of an uppermost surface of the upper clad layer.

### Configuration 2

In the optical waveguide chip described in Configuration 1, the height of the light absorbing material is not less than 0.1 mm and not greater than 1.5 mm from the uppermost surface of the upper clad layer.

### Configuration 3

In the optical waveguide chip described in Configuration 1 or Configuration 2, a fixture plate is provided on a top surface of an input waveguide of the optical waveguide chip.

### Configuration 4

In the optical waveguide chip described in any one of Configuration 1 to Configuration 3, an optical fiber is provided on an input end of the optical waveguide circuit.

### Configuration 5

In the optical waveguide chip described in any one of Configuration 1 to Configuration 3, a laser is provided on an input end of the optical waveguide chip.

### Configuration 6

The optical waveguide chip described in any one of Configuration 1 to Configuration 5 further includes:
a 3-dB branch optical waveguide configured to split input light having propagated through the input waveguide into two beams of light; and
a first output waveguide and a second output waveguide, each of which is configured to propagate one of the two beams of split input light,
where the light absorbing material is filled covering the first output waveguide and the second output waveguide.

### Configuration 7

The optical waveguide chip described in any one of Configuration 1 to Configuration 5 further includes:
a 3-dB branch optical waveguide configured to split input light having propagated through the input waveguide into two beams of light; and
a first output waveguide and a second output waveguide, each of which is configured to propagate one of the two beams of split input light,
where the light absorbing material is filled covering the first output waveguide and the second output waveguide.

### Configuration 8

A manufacturing method for an optical waveguide chip includes:
arranging sets of the optical waveguide chips described in any one of Configuration 1 to Configuration 7 on a plurality of wafers; and
performing cut and separation by cutting along a cutting line common to each of the sets of the optical waveguide chips after forming an optical waveguide and a light blocking structure by common optical waveguide formation processing and light blocking structure formation processing for each of the plurality of wafers.

### Effects of the Invention

According to the present invention, it is possible to suppress stray light while suppressing an increase in size of the optical waveguide chip. Additionally, since it is unnecessary to form a light blocking structure on the chip end surface, it is possible to suppress stray light without increasing the number of steps in the manufacturing process, and a reduction in cost can be expected.

### BRIEF DESCRIPTION OF DRAWINGS

FIG. 1 is a top view of an optical waveguide chip of conventional art.

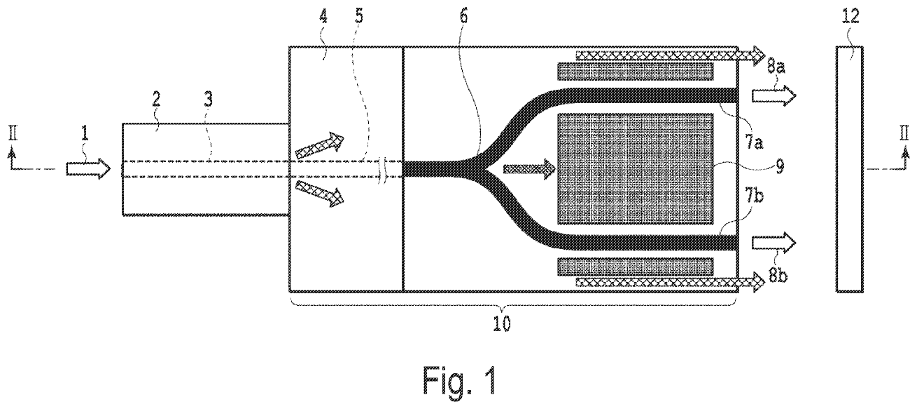

FIG. 2 is a substrate cross-sectional view taken along a line II-II of the optical waveguide chip of conventional art in FIG. 1.

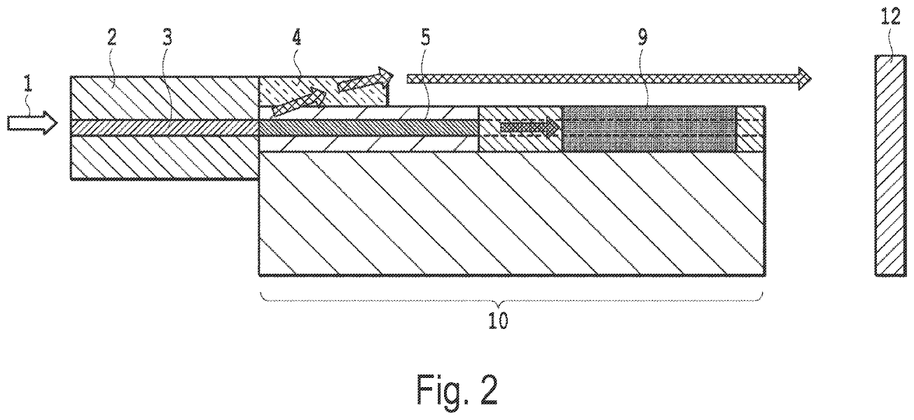

FIG. 3 is a top view of another optical waveguide chip of conventional art.

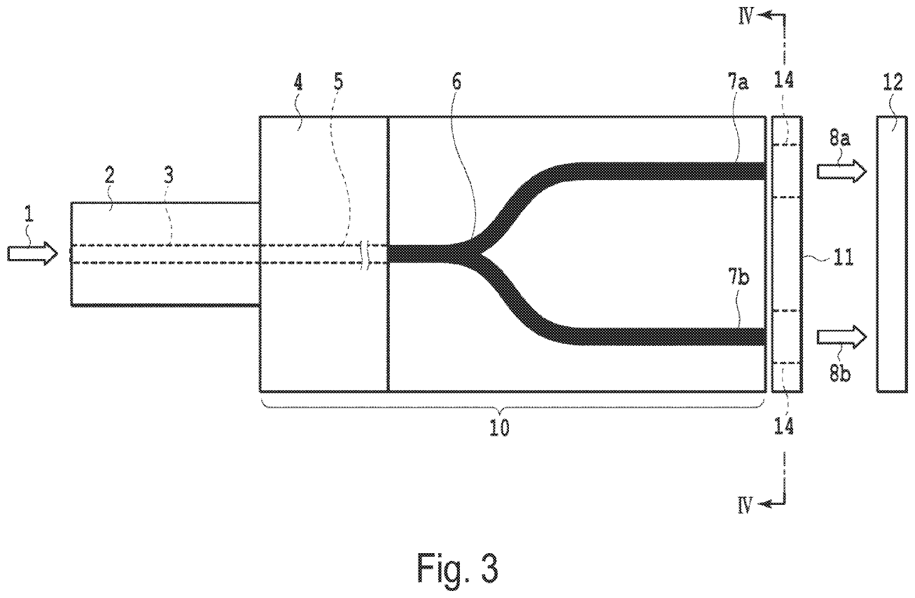

FIG. 4 is a cross-sectional view taken along a line IV-IV of the optical waveguide chip of conventional art in FIG. 3.

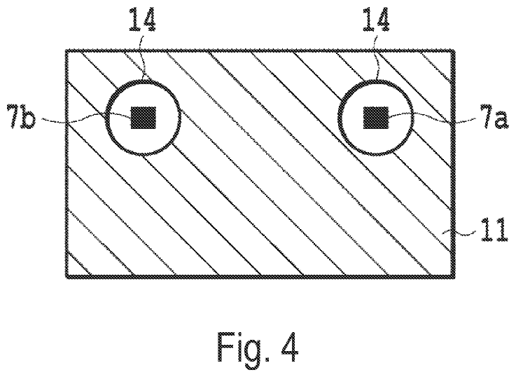

FIG. 5 is a top view of an optical waveguide chip of a first embodiment.

FIG. 6 is a substrate cross-sectional view taken along a line VI-VI of the optical waveguide chip of the first embodiment.

FIG. 7 is a cross-sectional view taken along a line VII-VII of the optical waveguide chip of the first embodiment.

FIG. 8 is a set of diagrams describing a manufacturing method for an optical waveguide chip of the first embodiment.

FIG. 9 is a diagram describing another manufacturing method for an optical waveguide chip according to the first embodiment.

FIG. 10 is a top view of an optical waveguide chip according to a second embodiment.

FIG. 11 is a cross-sectional view taken along a line XI-XI of the optical waveguide chip of the second embodiment.

FIG. 12 is a top view of an optical waveguide chip of a third embodiment.

### DESCRIPTION OF EMBODIMENTS

Hereinafter, embodiments of the present invention will be described in detail with reference to the drawings.

### First Embodiment

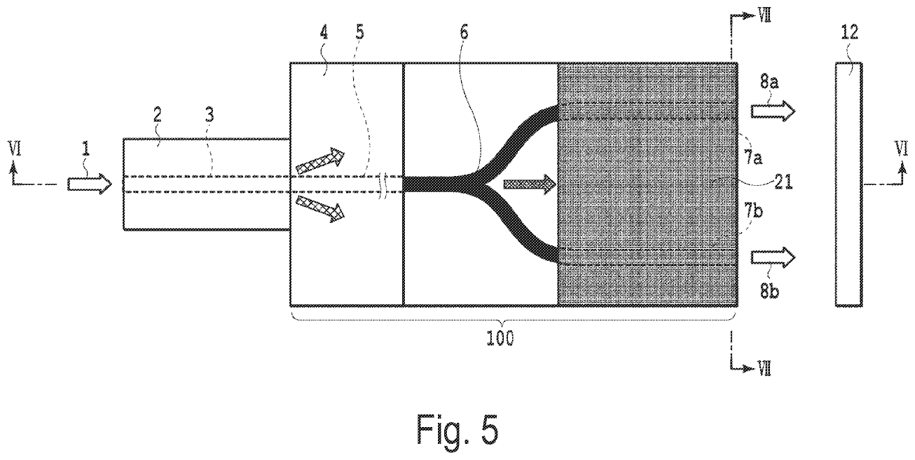

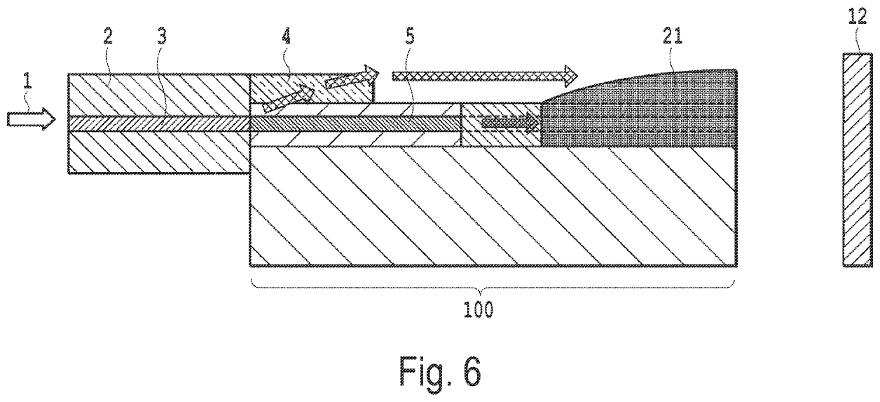

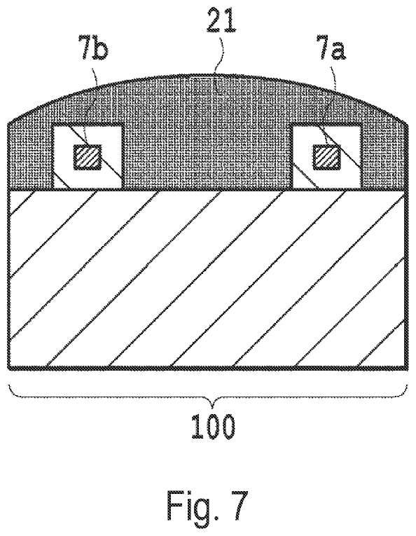

An optical waveguide chip according to a first embodiment of the present invention will be described with reference to FIGS. 5 to 7. FIG. 5 illustrates a top view of an optical waveguide chip 100 of the first embodiment. FIG. 6 is a substrate cross-sectional view including an optical axis of an input waveguide of the optical waveguide chip 100 of the first embodiment, and FIG. 7 illustrates a substrate cross-sectional view perpendicular to an optical axis of an output waveguide of the optical waveguide chip 100 of the first embodiment.

In FIG. 5, an optical fiber 3 attached to a fiber block 2 is connected to an input end of the optical waveguide chip 100 of the first embodiment, and a member called a fixture plate 4 is attached on a top surface of the optical waveguide chip 100 while the end surfaces thereof being flush with each other. The fiber block 2, the fixture plate 4, and the like are needed in order to, when a PLC and the optical fiber are bonded and fixed to each other, increase the bonding cross-sectional area and enhance mechanical strength of the bonding portion. The fiber block, the fixture plate, and the like are generally made of glass or the like (for example, see PTL 6).

In FIG. 5, a light receiving element 12 configured to receive output light 8a and output light 8b is disposed at output ends of first and second output waveguides 7a and 7b. Input light 1 input to the fiber 3 provided in the fiber block 2 propagates through an input waveguide of the optical waveguide chip, and the input light 1 having propagated through an input waveguide 5 is split into two beams of light in a 3-dB branch optical waveguide. One of the two beams of split light propagates through the first output waveguide 7a and is output as the output light 8a to the light receiving element 12. Likewise, the other one of the two beams of split light having been split in the 3-dB branch optical waveguide 6 propagates through the second output waveguide 7b and is output as the output light 8b to the light receiving element 12.

In the optical waveguide chip 100 of the first embodiment, a light blocking structure is formed in which a light blocking material (light absorbing material) 21 is formed covering the first output waveguide 7a and the second output waveguide 7b.

In the present embodiment, the light blocking material 21 is filled across to an edge of the chip as illustrated in FIG. 5. Then, as illustrated in the substrate cross-sectional view including the optical axis of the input waveguide in FIG. 6, the light blocking material 21 is formed up to a height higher than the uppermost surface of the upper clad layer by 0.1 mm or more in order to effectively eliminate stray light propagating through the space. In order to maintain a compact shape of the chip, the height of the light blocking material 21 is set to be not higher than 1.5 mm.

As a result, stray light that may propagate through the clad layer and may be superimpose on the light receiving element, stray light generated in the joining portion between the optical fiber and the input waveguide, and the like may be effectively absorbed and suppressed/eliminated. The light blocking material 21 is formed covering the top surfaces of the first output waveguide 7a and the second output waveguide 7b, as illustrated in the substrate cross-sectional view perpendicular to the optical axis of the output waveguide in FIG. 7.

In the optical waveguide chip 100 according to the first embodiment, the optical waveguide is a so-called planar optical integrated circuit. For example, a lower clad layer formed of quartz-based glass is provided on a surface of a silicon substrate, a core portion formed of quartz-based glass and corresponding to a propagation path of an optical signal is provided on a top surface of the clad layer, and an upper clad layer formed of quartz-based glass is provided on a top surface of the core portion. In a region on the outgoing end side of the optical waveguide chip that does not correspond to the propagation path of the optical signal, there is provided a region where the upper and lower clad layers are removed across to an edge of the chip, and this region is filled with the light blocking material 21. The height of the light blocking material is higher than the uppermost surface of the upper clad layer by at least 0.1 mm.

### Manufacturing Method for Optical Waveguide Chip

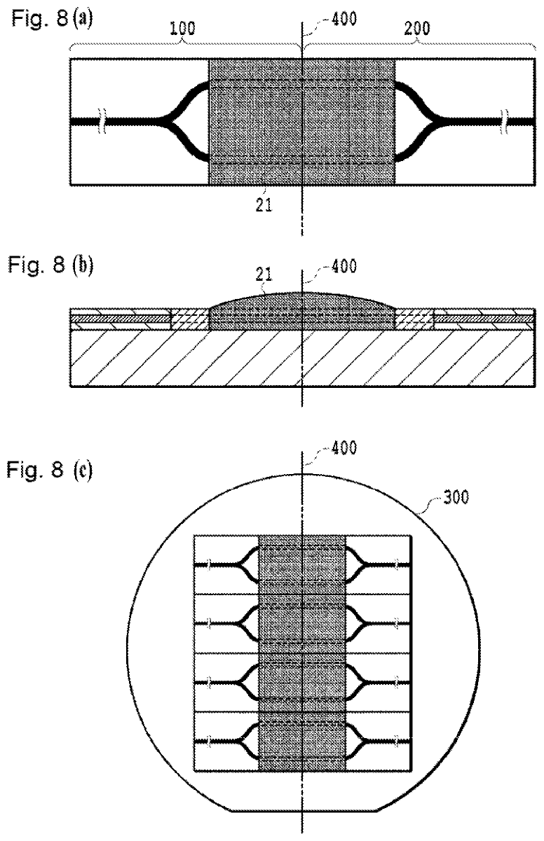

FIG. 8 is a set of diagrams describing a manufacturing method for the optical waveguide chip 100 according to the first embodiment.

FIG. 8(a) on the upper side is an enlarged substrate diagram where two optical waveguide chips, that is, a set of the optical waveguide chip 100 according to the first embodiment in FIG. 5 and an optical waveguide chip 200 according to the first embodiment, are disposed with their output waveguide sides facing each other; FIG. 8(a) is a top view, and FIG. 8(b) is a substrate cross-sectional view including the optical axis of the input waveguide. The set of chips is cut along a center cutting line 400 to be separated; as a result, two individual optical waveguide chips are obtained.

FIG. 8(c) on the lower side illustrates a silicon wafer 300, in which four sets of two optical waveguide chips illustrated in FIG. 8(a) are disposed as an example, that is, eight optical waveguide chips in total are illustrated. The cut and separation at the center cutting line 400 may be performed in the wafer state, or the cut may be performed after the four sets are separated into each individual set of chips. In a case where the sets of optical waveguide chips are disposed on the wafer in such a manner that the cutting line 400 serves as a cutting line common to each set of optical waveguide chips, the cut and separation at the cutting line 400 may be performed in the wafer state, which is efficient work.

The optical waveguide formation processing is as follows. First, a glass layer to serve as a lower clad is formed on a silicon substrate (the silicon wafer 300) using a flame hydrolysis deposition technique or the like. Then, on the glass layer, a glass material layer to serve as a core having a refractive index higher than that of the clad is formed by photolithography and etching techniques to form an optical waveguide pattern. Thereafter, a glass layer to serve as an upper clad is deposited again, so as to form a core built-in type optical waveguide.

Next, as for the light blocking structure formation processing, similarly to the time of forming the optical waveguide, after a region where the clad layers are removed is formed in a predetermined position in the wafer by the photolithography and etching techniques, the above region is filled with the light blocking material 21 and then the light blocking material 21 is cured.

The region to be filled with the light blocking material 21 is not necessary to be formed by removing all of the clad layers, and it is sufficient that the region is etched by at least 0.1 mm. The etching depth may be adjusted to make the light blocking material have a predetermined height (thickness), a surface with which the light blocking material makes contact may be physically or chemically modified, or the surface tension, wettability (contact angle) and the like of the light blocking material may be adjusted. In the present embodiment, the surface tension and the wettability (contact angle) of the light blocking material are adjusted to cause a cross section of the light blocking material to rise upward.

The light blocking material 21 in the present embodiment is formed by mixing a silicone resin as a base material and carbon black typically used as a light blocking material. Light that enters the light blocking material is attenuated in optical power primarily by absorption in the carbon black. The surface tension, the wettability, and the like may be adjusted by the selection of the base material. A thermosetting resin, a light curing resin, or the like may be used as the base material of the light blocking material.

The filling of the light blocking material needs to be carried out before cutting out a portion filled with the light blocking material, and is carried out in the wafer state in the present embodiment. The light blocking material is patterned in a predetermined position on the wafer by a dispenser, an ink jet printer, or screen printing. Thereafter, the light blocking material is cured by heat treatment when a thermosetting resin is used as the light blocking material, or by light irradiation when a light curing resin is used. After the light blocking structure is formed, the wafer is cut into individual chips by dicing.

The patterns of the regions for the optical waveguides and the filling of the light blocking material are constituted in such a manner that a second optical waveguide chip having the same pattern as that of a first optical waveguide chip is disposed to be line-symmetrical with respect to an outgoing surface of the first optical waveguide chip, and the pattern of the first optical waveguide chip and the pattern of the second optical waveguide chip are continued. This makes it possible to use the wafer area with zero waste.

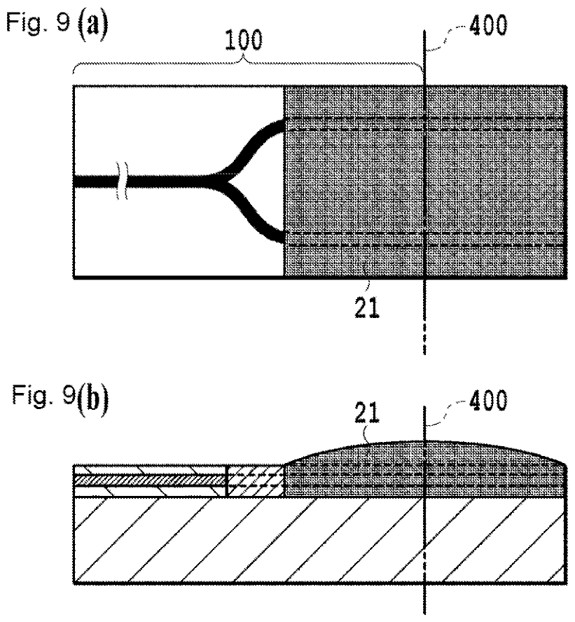

In the present embodiment, the first optical waveguide chip 100 and the second optical waveguide chip 200 have the same pattern, but may have different patterns. Only the first optical waveguide chip 100 may be patterned, and in this case, as illustrated in FIG. 9, a region to be filled with the light blocking material 21 is set to be longer than the chip length, and an extra chip may be cut out at the cutting line 400 in such a manner that the light blocking layer is exposed to the output end surface after filling and curing the light blocking material 21.

In the present embodiment, a case of the glass-based waveguide is described, but an InP waveguide, a GaAs waveguide, a LiNbO₃ waveguide, a polymer waveguide, or the like may also be used.

In the present embodiment, an example is described in which light leaking from the joining portion between the optical fiber and the input waveguide, and light leaking from the 3-dB branch optical waveguide are eliminated by the light blocking material, and in a case where there exists a portion where light leaks in the waveguide circuits having other shapes, it is possible to eliminate/suppress the stray light by forming a region to be filled with the light blocking material in the vicinity of the light leaking portion. For example, as a portion where light leaks, a bend portion (in particular, when the radius of curvature is small) or a portion where multiplexing or demultiplexing is performed may be cited.

### Second Embodiment

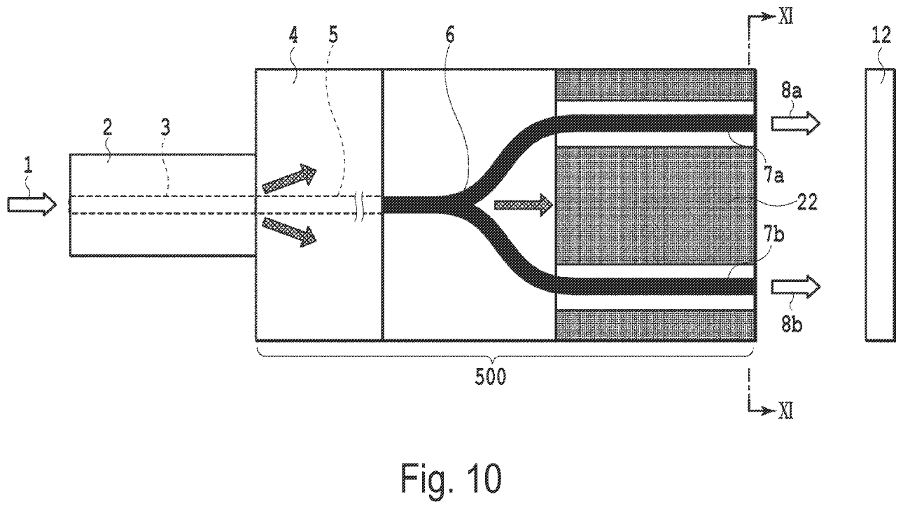

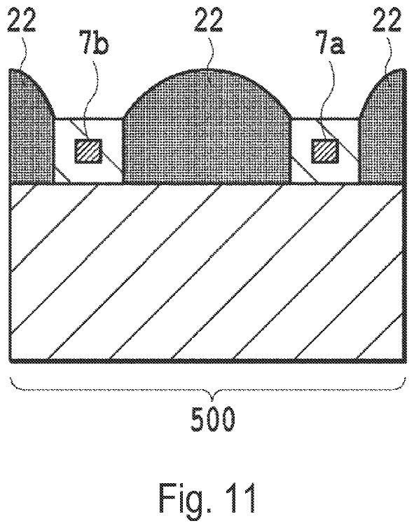

An optical waveguide chip according to a second embodiment will be described with reference to FIGS. 10 and 11. FIG. 10 illustrates a substrate top view of an optical waveguide chip 500 of the second embodiment. FIG. 11 is a substrate cross-sectional view (a cross section taken along a line XI-XI) perpendicular to an optical axis of an output waveguide of the optical waveguide chip 500 of the second embodiment.

The configuration of the optical waveguides of the second embodiment is the same as that of the first embodiment. A point different from the first embodiment is an application region of a light blocking material 22. As illustrated in the substrate cross-sectional view in FIG. 11, in the optical waveguide chip 500 of the second embodiment, only a region where the clad layers are removed is filled with the light blocking material 22, and the light blocking material 22 does not cover the top surfaces of a first output waveguide 7a and a second output waveguide 7b. When the height of the applied light blocking material 22 is higher than or equal to a predetermined height and an output point of the output waveguide is not visible from a generation point of stray light, it is possible to eliminate the stray light without covering the top surfaces of the first output waveguide and the second output waveguide because the midway light blocking material blocks the stray light.

### Third Embodiment

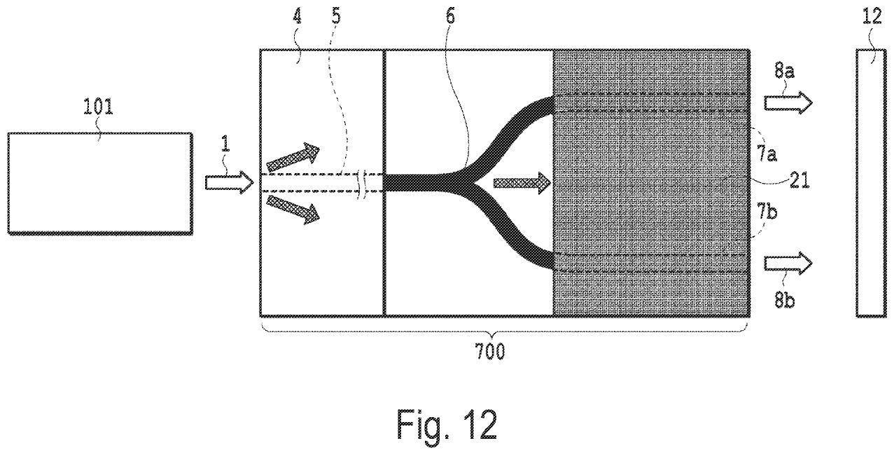

An optical waveguide chip according to a third embodiment will be described with reference to FIG. 12. FIG. 12 illustrates a top view of an optical waveguide chip 700 according to the third embodiment. The configuration of the optical waveguides according to the present embodiment is the same as that of the first embodiment. A point different from the first embodiment is that a laser 101 instead of an optical fiber is provided on the input side of the optical waveguide chip 700. According to the present embodiment, stray light generated in a joining portion between the laser and the input waveguide, or the like may also be absorbed by the light blocking material, and the degradation in the characteristics may be suppressed.

### INDUSTRIAL APPLICABILITY

As described thus far, according to the present invention, it is possible to suppress stray light while suppressing an increase in size of the optical waveguide chip. Additionally, since it is unnecessary to form a light blocking structure on the chip end surface, it is possible to suppress stray light without increasing the number of steps in the manufacturing process, and reduce the manufacturing cost.

1. An optical waveguide chip comprising:
an optical waveguide circuit,
wherein the optical waveguide circuit includes
a substrate,
a lower clad layer laminated on the substrate,
a core layer that is laminated on the lower clad layer and corresponds to a propagation path of an optical signal, and
an upper clad layer laminated on the core layer,
the upper clad layer and the lower clad layer in a region that does not correspond to the propagation path of the optical signal are removed across to an edge of the optical waveguide chip,
the region from which the upper clad layer and the lower clad layer have been removed is filled with a light absorbing material, and
a height of the filled light absorbing material is higher than a height of an uppermost surface of the upper clad layer.

2. The optical waveguide chip according to claim 1, wherein the height of the light absorbing material is not less than 0.1 mm and not greater than 1.5 mm from the uppermost surface of the upper clad layer.

3. The optical waveguide chip according to claim 1, wherein a fixture plate is provided on a top surface of an input waveguide of the optical waveguide chip.

4. The optical waveguide chip according to claim 1, wherein an optical fiber is provided on an input end of the optical waveguide circuit.

5. The optical waveguide chip according to claim 1, wherein a laser is provided on an input end of the optical waveguide chip.

6. The optical waveguide chip according to claim 1, further comprising:
a 3-dB branch optical waveguide configured to split input light having propagated through the input waveguide into two beams of light; and
a first output waveguide and a second output waveguide, each of which is configured to propagate one of the two beams of split input light,
wherein the light absorbing material is filled covering the first output waveguide and the second output waveguide.

7. The optical waveguide chip according to claim 1, further comprising:
a 3-dB branch optical waveguide configured to split input light having propagated through the input waveguide into two beams of light; and
a first output waveguide and a second output waveguide, each of which is configured to propagate one of the two beams of split input light,
wherein the light absorbing material is filled without covering top surfaces of the first output waveguide and the second output waveguide.

8. A manufacturing method for an optical waveguide chip, comprising:
arranging sets of the optical waveguide chips according to claim 1 on a plurality of wafers; and
performing cut and separation by cutting along a cutting line common to each of the sets of the optical waveguide chips after forming an optical waveguide and a light blocking structure by common optical waveguide formation processing and light blocking structure formation processing for each of the plurality of wafers.
